(19) United States
(12) Patent Application Publication
(10) Pub. No.: US 2005/0121891 A1
(43) Pub. Date: Jun. 9, 2005

(54) Airbag having conductive material and system and method for adjustment of deployment characteristics of airbag having conductive material

(75) Inventor: John Alexander Sollars JR., LaGrange, GA (US)

Correspondence Address: John E. Vick, Legal Department, M-495, PO Box 1926, Spartanburg, SC, 29304, US

(73) Assignee: Milliken & Company

(21) Appl. No.: 10/726,414

(22) Filed: Dec. 3, 2003

(51) Int. Cl. B60R 21/32

(52) U.S. Cl. 280/735

(57) ABSTRACT

A system, apparatus and method for effectively deploying a safety restraint cushion is disclosed. An inflatable airbag adapted for deployment into a deployment region of a passenger vehicle is described. The inflatable airbag may have applied to or embedded within the fabric or textile of the airbag a conductive material. An electromagnetic field generating device provides an electromagnetic field within the deployment region. A sensing device is adapted for detecting the presence and relative position of said conductive material within said electromagnetic field. A control system is adapted for receiving signals indicating position, and determining if the signals are within pre-defined operational parameters. If not within such parameters the control system may send feedback signals in real time to alter the characteristics of deployment of the airbag to accommodate a perceived object or out-of-position passenger in the immediate pathway of the airbag.

### BACKGROUND OF THE INVENTION

Automotive airbags are manufactured and installed in vehicles to cushion the impact of passengers in the event of a collision. Airbags for protection against frontal impact are typically designed for protecting the driver and the front seat passenger. Airbags also are used to protect against rollover type collisions, and in that instance may be installed along the interior roofline of a vehicle for deployment downward. This downward deployment of side impact (or “side curtain”) airbags serves to cushion the sides of the vehicle during a rollover event.

It is known that in some instances airbags do not achieve their purpose or full potential when passengers are not in their normal seated position at the precise moment the airbag is deployed. In that instance, the airbag may not achieve its intended purpose at all. If objects are in the pathway of the airbag near its point of deployment, the airbag will not deploy correctly. In other instances, continued deployment may sometimes increase risk of injury to an occupant.

U.S. patent application Publication No. 2003/0052479 A1 is directed to an airbag system for a motor vehicle that includes a sensing device for sensing deployment of the airbag. Opening of the folds of the airbag may be detected by severing “jumpers”, or electrical wiring embedded in the airbag, which causes a circuit to detect a full electrical resistance value.

In a second embodiment of the above noted publication, a contact-less transmitting/receiving device is disclosed for radiating ultrasound, light, or infared radiation into the interior of the airbag. This radiation is reflected by a reflector mounted on the airbag. The signal optionally may be evaluated with respect to frequency variation as a result of the Doppler effect. The wavelength of reflected signals may be evaluated. When an obstacle is present in the airbag pathway, variation in frequency of the detected signal occurs. This system requires that the wavelength of reflected signals be interpreted accurately and reliably, which sometimes can be difficult in such an environment.

It therefore would be helpful to devise a system or apparatus that is capable of directly and reliably detecting improper or inefficient deployment of an airbag by more direct measurement of airbag position. It would then be possible, in response, to quickly adjust or change deployment characteristics of the airbag during the deployment event. Improved apparatus for precisely and accurately detecting and making such real time corrections would be very beneficial.

### BRIEF DESCRIPTION OF THE DRAWINGS

A full and enabling disclosure of this invention, including the best mode shown to one of ordinary skill in the art, is set forth in this specification. The following Figures illustrate the invention:

FIG. 1 is a perspective view of the passenger compartment of a vehicle equipped with the system of the invention;

FIG. 2 shows a typical airbag deployment in a situation in which a passenger is seated in a normal riding position;

FIGS. 3-4 depict a deployment situation in which a passenger is undesirably out-of-position during the deployment event, in this case due the passenger head and shoulders in proximity to the airbag deployment site at the precise moment of airbag deployment;

FIGS. 5-6 show an illustration of an object in the airbag pathway during airbag deployment; and

FIG. 7 is a functional flow diagram showing a typical sequence of events in the practice of the invention.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

In the practice of the invention, a system for effectively deploying a safety restraint cushion may be employed. An inflatable airbag adapted for deployment into a deployment region of a passenger vehicle can be used. The inflatable airbag may include within the yam, or in the surface of the airbag, a conductive material. An electromagnetic field generating device provides an electromagnetic field within the deployment region. A sensing device is adapted for detecting the presence and relative position of the said conductive material. A control system is adapted for receiving signals, and in response, sending feedback signals in real time to alter the characteristics of deployment of the airbag.

In one embodiment of the invention, the leading edge of the airbag fabric or textile may be constructed of or coated with a substance that includes a different overall conductivity than the remainder of the fabric of the airbag. This may be accomplished in several different ways. For example, a section of the leading edge of the fabric of the airbag may be woven using conductive fiber yarns, or yarns with metallic fibers.

In other embodiments, it may be possible to coat a conductive or metallic substance directly upon the leading edge of the airbag fabric during airbag fabric manufacture. In other applications, it would be useful to employ an RF resonator or similar device (or passive device) into the airbag itself. This could be accomplished, for example, by employing at least two of such resonator or passive devices in separate portions of the airbag, for a spatial measuring effect. Still other physical embodiments of the invention may be possible as within the spirit and scope of the invention, which are not herein specifically described.

In one application of the invention, a capacitance or other type of sensing coil or electric field generating device may be incorporated into the airbag module, dashboard of the vehicle, steering wheel, or other structure in the interior of the vehicle. As the bag is deployed, the conductive area of the front part of the airbag disrupts an electric field. Associated electronics or control systems on board the vehicle may determine the strength and thus the relative position of the front of the airbag in relation to the surrounding space.

It is possible by making computations to utilize the relative position of the airbag leading edge over time. The velocity of the leading edge may be determined at any given moment in time. Changes in the velocity may be used to deduce the acceleration of the leading edge of the airbag at a given moment in time. A sudden change in velocity or acceleration, that deviates from stored values of a normal unimpeded deployment, may indicate that the leading edge of the airbag has encountered an object such as child safety seat or an out-of-position occupant. Then, a signal from the control unit can be utilized to modify airbag deployment sequences to account for the undesirable consequence. Feedback from a sensing system may be used to control or throttle the output of an airbag inflator, or to open a gas bypass valve or port, or to change the deployment characteristics of the airbag. This may prevent or minimize the application of excessively high forces to objects or out-of-position occupants, in some particular situations.

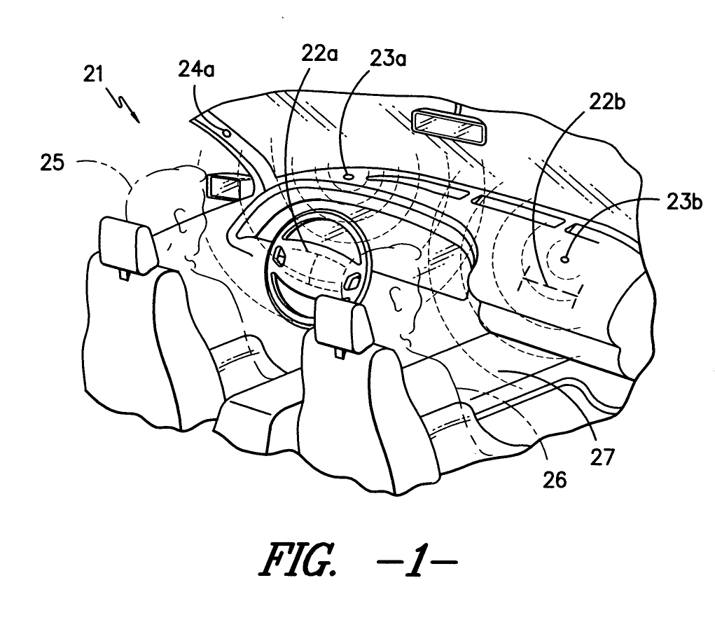

Turning to FIG. 1, an interior of a passenger vehicle 21 is shown which includes airbag deployment sites 22a (driver) and 22b (passenger). Typically, the invention applies to a passenger airbag, but under certain circumstances it may apply to a driver side airbag or a side inflating airbag. Thus, FIG. 1 shows the possible application to either a passenger or a driver. An electromagnetic field generating device 23a, 23b is provided for establishing an electromagnetic field 27 in the vicinity of the interior of the vehicle 21. A sensing device 24a is shown, and a similar device 24b (not seen in FIG. 1) is provided as well on the passenger side of the vehicle 21. Driver 25 and passenger 26 are in the normal and customary position for vehicular travel.

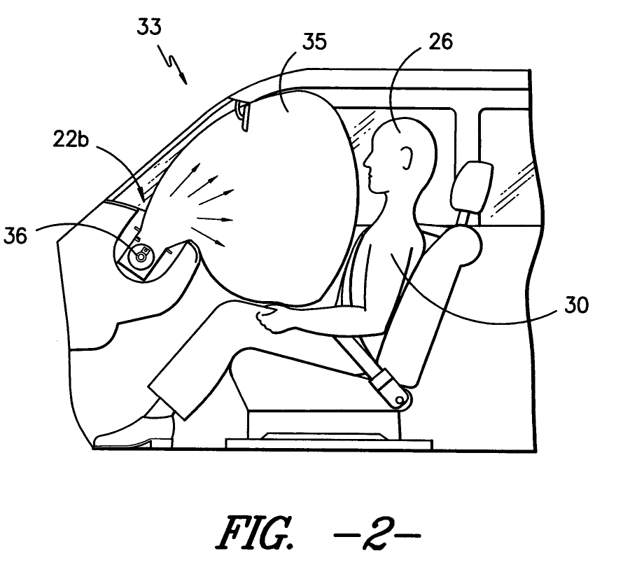

FIG. 2 illustrates a normal airbag deployment illustrating correct passenger positioning 33. Airbag 35 is ejected from the airbag deployment site 22b by activation of inflation device 36. Passenger 26 is in a position to facilitate relatively full airbag deployment prior to substantial forward movement of his/her upper torso 30 during the front end impact event.

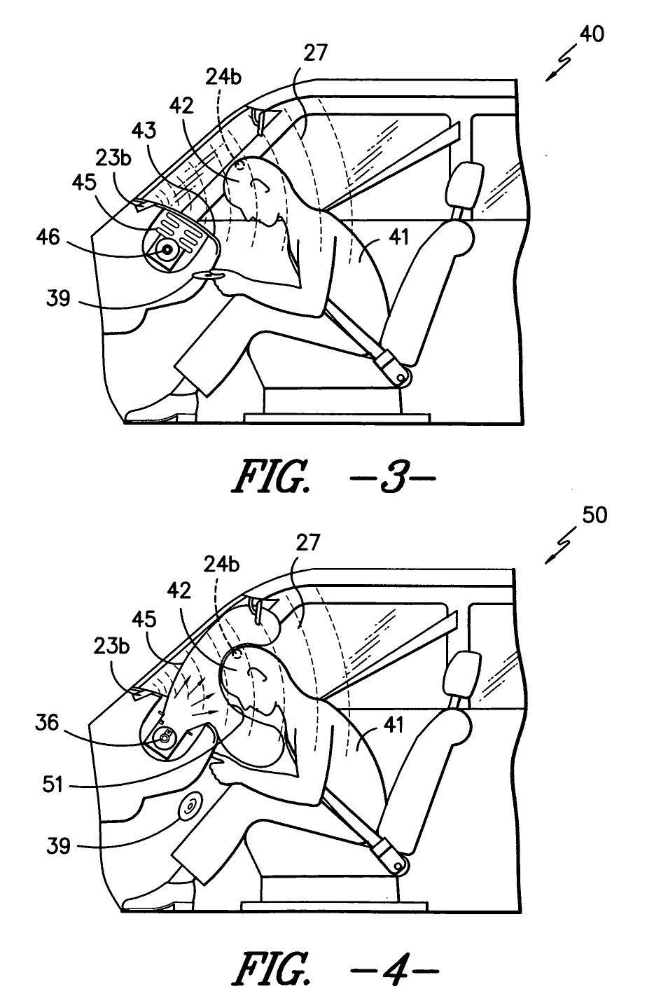

In FIGS. 3-4, a situation that accomodates the application of the invention is illustrated, in which an out-of-position passenger 40 (a person on the passenger side of the car) at the moment of impact 50 undesirably has leaned to a position near the dashboard 43 while manipulating a magnetic media 39 for insertion into a radio/music player. The body 41 and head 42 of the out-of-position passenger 40 are shown. The inflation device 46 ejects gas into the airbag 45. The airbag 45 includes a fabric having conductive material embedded within the fabric of the airbag 45. The airbag 45, once ejected, moves through the electromagnetic field 27. A leading edge 51 of the airbag is deformed upon impact with head 42, as shown in the FIG. 4. The sensor 24b is capable of detecting conductive material in the leading edge 51. A control system (not shown) may compare the readings with predetermined normal values (as shown in FIG. 2, for example) to ascertain that the leading edge 51 indeed undesirably has struck the out-of-position passenger 40 too early in the deployment sequence. This may be determined, and corrective action taken by the control system (not shown). Various types of corrective action are possible, as further discussed herein.

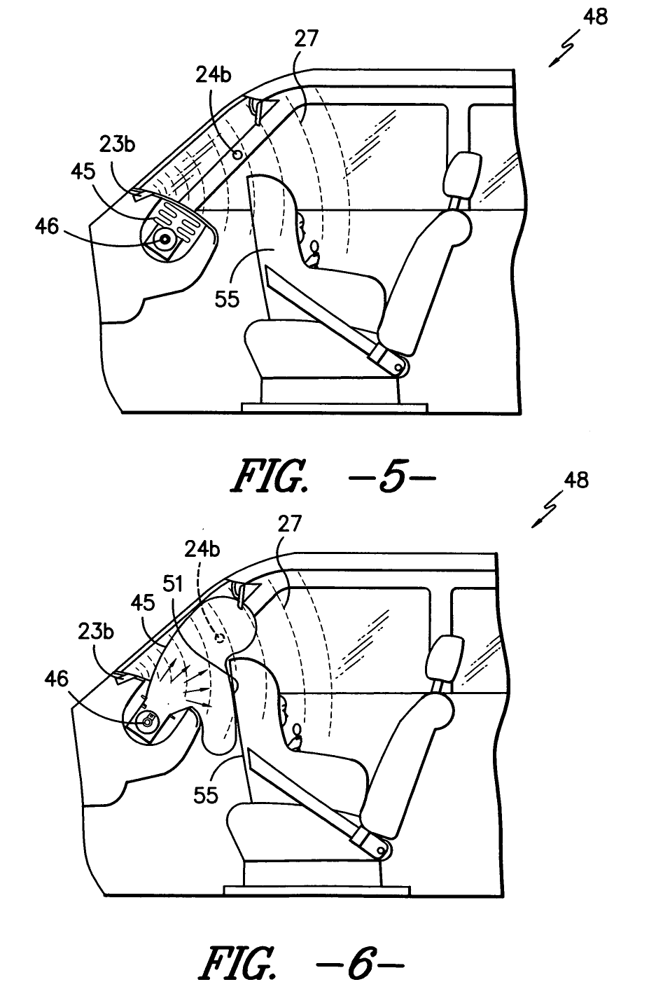

FIGS. 5-6 show yet another situation of an incorrect object placement 48 in which an object 55 (in this case an infant seat) undesirably lies within the pathway of airbag deployment on the passenger (non-driver) side of a vehicle. The airbag 45 having conductive material (not shown) within the leading edge 51 of the airbag 45 contacts the object 51. This incorrect deployment may be ascertained by sensor 24b, which in response dispatches electrical signals to a control system (not shown), which is then able to take corrective action.

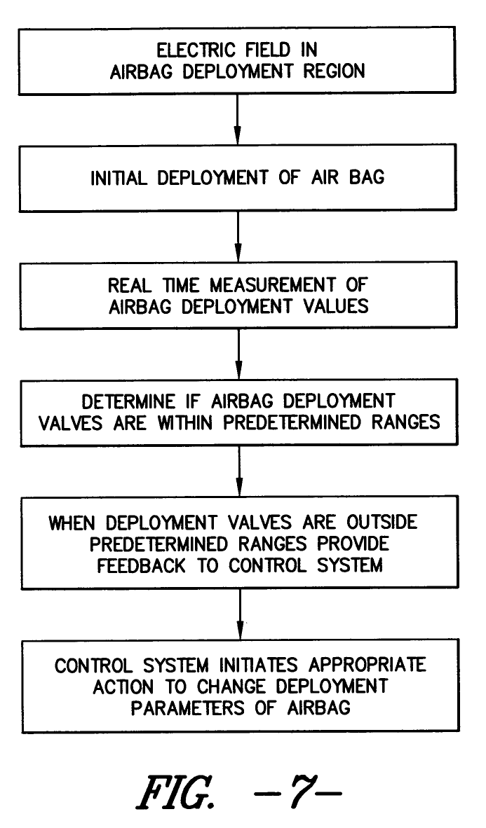

FIG. 7 illustrates a sequence of events which may occur in the practice of the invention. When sensed values are not within predetermined ranges (i.e. ranges or values which are pre-loaded in memory of the electronic control system, for example), then feedback signals initiate appropriate action. This action may include, for example, actions serving to minimize or customize an airbag deployment sequence to account for the undesirable consequence.

Feedback from a sensing system may be used to control the output of an airbag inflator, in some instances. Airbag systems may use two separate inflators. In that instance, the second inflator or auxiliary inflator having a second or auxiliary gas charge may be disabled in the practice of the invention when an out-of-position passenger or object is detected, thereby reducing the force applied by the airbag upon the out-of-position passenger or object. In other applications, the excess gas may be diverted downward into the passenger compartment (as by way of a bypass valve or port which may be opened very quickly), to reduce the force the airbag exerts upon the out-of-position passenger or object. This “real time” detection/control may prevent or minimize the application of excessively high forces to objects or out-of-position occupants.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A system for effectively deploying a safety restraint cushion, comprising:
(a) an inflatable airbag, said inflatable airbag being adapted for deployment into a deployment region within the interior of a vehicle, said inflatable airbag further having a leading edge configured for impact with a person, said leading edge comprising a conductive material;
(b) an electromagnetic field generating device, said device being adapted for generating an electromagnetic field within said deployment region;
(c) a sensing device, said sensing device being adapted for detecting the presence within said deployment region of said conductive material; and
(d) a control system adapted for receiving signals from said sensing device and in response sending feedback signals in real time, said feedback signals being configured for altering the characteristics of the deployment of said inflatable airbag.

2. The system of claim 1 wherein said system further comprises an inflation device, said inflation device being adapted for emitting gas into said airbag to inflate and thereby deploy said airbag into said deployment region, further wherein said control system is adapted for sending said feedback signals to said inflation device in controlling the deployment of said inflatable airbag.

3. The system of claim 2 wherein said inflation device is adapted for releasing gas to a gas bypass pathway upon receiving said feedback signals.

4. The system of claim 1 wherein said system further comprises an inflation device, said inflation device being adapted for emitting gas into said airbag in a primary gas charge and at least one supplemental gas charge, wherein said inflation device is adapted for receiving feedback signals from said control system to inactivate said supplemental gas charge.

5. A system for providing a real time reduction in applied force of a safety restraint cushion for an automobile, comprising:
(a) an inflatable airbag, said inflatable airbag being adapted for receiving gas from an inflation device to accommodate expansion of said airbag into a deployment region within the interior of an automobile, said inflatable airbag further comprising a textile, wherein said textile comprises a leading edge that extends into said deployment region upon inflation of said airbag, said leading edge of said textile further comprising conductive material, wherein said conductive material is configured for generating an electromagnetic response when passing through an electromagnetic field;
(b) an electromagnetic field generating device, said device being mounted in the interior of said automobile, said electromagnetic field generating device being adapted for generating an electromagnetic field within said deployment region in the interior of said automobile;
(c) an electromagnetic sensing device, said sensing device being adapted for detecting the presence and relative position within said deployment region of said conductive material; and
(d) a control system configured for receiving signals from said sensing device and in response dispatching feedback signals in real time during said deployment of said airbag, said feedback signals being configured for reducing the force applied by said leading edge of said airbag.

6. An inflatable airbag comprising a woven fabric, said fabric comprising a leading edge adapted for extending into the interior of a vehicle during inflation of said airbag, said woven fabric further comprising a conductive material capable of exhibiting an electromagnetic response in the presence of an electromagnetic field.

7. The inflatable airbag of claim 6 wherein said conductive material comprises fibers interwoven into said fabric of said airbag.

8. The inflatable airbag of claim 7 wherein said fibers comprise a metallic filament.

9. The airbag of claim 7 wherein said fibers include conductive polymeric material.

10. The inflatable airbag of claim 6 wherein said conductive material is applied as a coating to said leading edge of said fabric.

11. The airbag of claim 10 wherein said conductive material comprises a metallic material.

12. The inflatable airbag of claim 6 wherein said conductive material comprises at least one RF resonator integrally formed or coated into said leading edge of said fabric.

13. The inflatable airbag of claim 12 wherein said conductive material comprises at least two RF resonators integrally formed into said leading edge of said fabric.

14. A method of altering the deployment positioning of an inflatable airbag during deployment of the airbag in response to the detected position of objects or out-of-position passengers in the pathway of the airbag, said method comprising:
(a) providing an inflatable airbag, said airbag comprising an inflation mechanism for deploying a fabric, said fabric having a leading edge, said leading edge comprising an electromagnetically conductive material;
(b) providing an electromagnetic field generating device and a control system;
(c) generating an electromagnetic field in the vicinity of said airbag;
(d) deploying said airbag into said electromagnetic field;
(e) electromagnetically sensing the presence in said electromagnetic field of said conductive material of said leading edge of said airbag, and determining the position of said conductive material upon said leading edge of said airbag at more than one point in time to determine the characteristics of motion of said airbag during deployment;
(f) comparing the characteristics of step (e) with predetermined ranges or values to detect if objects are present in the pathway of said airbag; and
(g) sending feedback signals to said control mechanism, and
(h) altering the conditions for deployment for said airbag in response to said detected objects.

15. The method of claim 14 wherein said characteristics of motion of said airbag which are determined in step (e) include values of the relative velocity of the leading edge of said airbag during deployment.

16. The method of claim 14 wherein said characteristics of motion of said airbag which are determined in step (e) include values of the acceleration of said airbag during deployment.

17. The method of claim 14 wherein said feedback signals alter the inflation mechanism by opening a gas flow bypass port.

18. The method of claim 14 wherein said electromagnetically conductive material in step (a) comprises metallic fibers.

19. The method of claim 18 wherein said metallic fibers are woven into said fabric of said airbag.

20. The method of claim 14 wherein said electromagnetically conductive material comprises an conductive coating.

21. The method of claim 14 wherein said electromagnetically conductive material comprises a resonator.
